(19) United States
(12) Patent Application Publication
(10) Pub. No.: US 2013/0290870 A1
(43) Pub. Date: Oct. 31, 2013

(54) Inter-Conference Alerts for Simultaneous Online Conferences

(71) Applicant: TELECONFERENCING SERVICES, LTD., Atlanta, GA (US)

(72) Inventors: Boland T. Jones, Atlanta, GA (US); David Michael Guthrie, Norcross, GA (US); Mark A. Sjurseth, Smyrna, GA (US); John P. Keane, Marietta, GA (US)

(21) Appl. No.: 13/828,688

(22) Filed: Mar. 14, 2013

Related U.S. Application Data
(63) Continuation-in-part of application No. 12/771,979, filed on Apr. 30, 2010.
Application No. 12/771,979 is a continuation-in-part of application No. 12/772,069, filed on Apr. 30, 2010.
Application No. 12/772,069 is a continuation-in-part of application No. 13/078,277, filed on Apr. 1, 2011.
Application No. 13/078,277 is a continuation-in-part of application No. 13/078,132, filed on Apr. 1, 2011.

(51) Int. Cl. H04L 29/06

(52) U.S. Cl. CPC H04L 65/403
USPC 715/753

(57) ABSTRACT

Various embodiments of systems, methods, and computer programs are disclosed for simultaneously providing multiple online conferences via a conference user interface. One embodiment is a computer program embodied in a computer readable medium and executable by a processor for enabling simultaneous participation in at least two online conferences. The computer program comprises: logic configured to establish a first online conference with a first set of participants and a second online conference with a second set of participants, the first and second sets of participants having a common participant simultaneously participating in both; logic configured to present the first online conference via a conference user interface to a client device associated with the common participant; and logic configured to notify the common participant, via the conference user interface, of predetermined events occurring in the secondary conference.

### CROSS-REFERENCE TO RELATED APPLICATIONS

This application is a continuation-in-part patent application of and claims the benefit of the priority of the following copending patent applications, each of which is hereby incorporated by reference in its entirety: U.S. patent application Ser. No. 12/771,979 entitled “Conferencing Alerts” and filed on Apr. 30, 2010 (Attorney Docket No. 1202U1); U.S. patent application Ser. No. 12/772,069 entitled “Managing Conference Sessions via a Conference User Interface” and filed on Apr. 30, 2010 (Attorney Docket No. 16003.1210U1); U.S. patent application Ser. No. 13/078,277, entitled “Managing Multiple Conferences via a Conference User Interface” and filed on Apr. 1, 2011 (Attorney Docket No. 16003.1232U1); and U.S. patent application Ser. No. 13/078,132, entitled “Systems, Methods, and Computer Programs for Monitoring a Conference and Communicating with Participants without Joining as a Participant” and filed on Apr. 1, 2011 (Attorney Docket No. 16003.1233U1).

### BACKGROUND

Currently, there are a number of conference solutions for enabling people to conduct live meetings, conferences, presentations, or other types of gatherings via the Internet, the public switched telephone network (PSTN), or other voice and/or data networks. Participants typically use a telephone, computer, or other communication device that connects to a conference system. The meetings include an audio component and a visual component, such as, a shared presentation, video, whiteboard, or other multimedia, text, graphics, etc. These types of convenient conference solutions have become an indispensable form of communication for many businesses and individuals.

Despite the many advantages and commercial success of existing conference, meeting, grouping or other types of gathering systems, there remains a need in the art for improved conference, meeting, grouping or other types of gathering systems, methods, and computer programs.

### SUMMARY

Various embodiments of systems, methods, and computer programs are disclosed for simultaneously providing multiple online conferences via a conference user interface. One embodiment is a method comprising: a conferencing system establishing a first online conference with a first set of participants and a second online conference with a second set of participants, the first and second sets of participants having a common participant simultaneously participating in both; the conferencing system presenting a conference user interface to a client device associated with the common participant; the common participant designating the first online conference as a primary conference and the second online conference as a secondary conference; the conferencing system providing the primary conference to the client device in the conference user interface; the conferencing system monitoring and determining an event occurring in the secondary conference; and in response to the event, the conferencing system presenting a notification to the client device, via the conference user interface, the notification indicating the occurrence of the event in the secondary conference.

Another embodiment is a computer system comprising a conferencing system and a server. The conferencing system establishes a first online conference with a first set of participants and a second online conference with a second set of participants. The first and second sets of participants have a common participant simultaneously participating in both. The server is configured to communicate with the conferencing system via a communication network. The server comprises one or more processors and an inter-conference alert module, which is stored in a computer readable medium and executed by the processors for enabling the common participant to simultaneously participate in the first and second online conferences. The inter-conference alert module comprises: logic configured to designate the first online conference as a primary conference and the second online conference as a secondary conference; logic configured to present the primary conference via a conference user interface to a client device associated with the common participant; and logic configured to notify the common participant, via the conference user interface, of predetermined events occurring in the secondary conference.

A further embodiment is a computer program embodied in a computer readable medium and executable by a processor for enabling simultaneous participation in at least two online conferences. The computer program comprises: logic configured to establish a first online conference with a first set of participants and a second online conference with a second set of participants, the first and second sets of participants having a common participant simultaneously participating in both; logic configured to present the first online conference via a conference user interface to a client device associated with the common participant; and logic configured to notify the common participant, via the conference user interface, of predetermined events occurring in the secondary conference.

### BRIEF DESCRIPTION OF THE DRAWINGS

FIG. 1 is a block diagram illustrating an embodiment of a computer system for controlling simultaneous online conferences.

FIG. 2 is a block diagram illustrating an embodiment of the inter-conference alert module of FIG. 1.

FIG. 3 is a flow chart illustrating the architecture, operation, and/or functionality of an embodiment of the inter-conference alert module of FIGS. 1 & 2.

FIG. 4 is a block diagram illustrating an embodiment of a data structure for controlling a common participant's audio stream between a primary conference and a secondary conference.

FIG. 5a is a screen shot illustrating an embodiment of a conference user interface associated with the inter-conference alert modules of FIGS. 1-3 for enabling a participant to receive alerts from a secondary online conference while participating in a primary online conference.

FIG. 5b illustrates an embodiment of an alert message displayed in the conference user interface of FIG. 5a.

FIG. 5c illustrates an embodiment of an alert response menu displayed in the conference user interface of FIG. 5a.

FIG. 6 is a block diagram illustrating an embodiment of the multi-conference display module of FIG. 1.

FIG. 7a is a screen shot illustrating an embodiment of a multi-conference user interface for simultaneously participating in multiple online conferences.

FIG. 7b illustrates the multi-conference user interface of FIG. 7a in which the audio portion of the secondary conference user interface is activated.

FIG. 7c illustrates the multi-conference user interface of FIG. 7a in which the common participant has toggled the primary and secondary conference user interfaces.

FIG. 7d illustrates an embodiment of an alert settings menu.

FIG. 8 is a flow chart illustrating the architecture, operation, and/or functionality of an embodiment of the multi-conference display module of FIGS. 1 & 6.

FIG. 9a is a screen shot illustrating an embodiment of a multi-conference control panel displayed in a conference user interface.

FIG. 9b illustrates an embodiment of a multi-conference dashboard.

### DETAILED DESCRIPTION

Various embodiments of systems, methods, and computer programs are disclosed for providing simultaneous conferences to a common participant via a conference user interface. Each conference may comprise an online conference, meeting, grouping, or other types of gatherings (collectively, a “conference”, with a system that provides the conference being referred to as a “conferencing system”) for any variety of purposes of one or more people, groups or organizations (including combinations thereof and collectively referred to as “participants”) with or without an audio component, including, without limitation, enabling simulcast audio with such conference for the participants. Exemplary embodiments of the conference, conferencing system, conference user interface, and related features may be implemented as described in the parent patent applications, U.S. patent application Ser. Nos. 12/771,979, 12/789,993, and 12/772,069, the entire contents of which are hereby incorporated by reference into this specification.

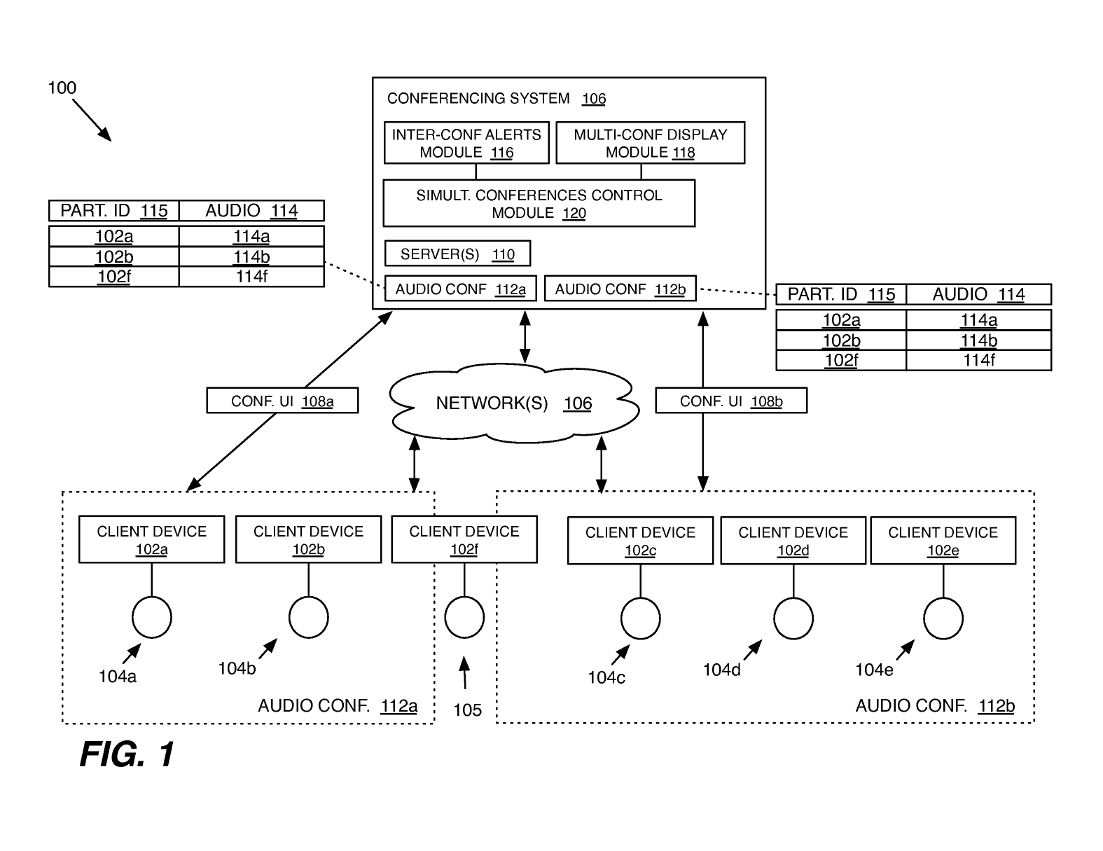

FIG. 1 illustrates an embodiment of a computer system 100 for providing simultaneous online conferences (e.g., audio conferences 112a and 112b) to a common participant 105. The computer system 100 comprises a plurality of computing devices 102 in communication with a conferencing system 106 via one or more communication networks 110. The network(s) 110 may support wired and/or wireless communication via any suitable protocols, including, for example, the Internet, the Public Switched Telephone Network (PSTN), cellular or mobile network(s), local area network(s), wide area network(s), or any other suitable communication infrastructure.

The conferencing system 106 may establish two separate audio conferences 112a and 112b in which there is at least one common participant 105 (i.e., simultaneously participating in both audio conferences 112). As illustrated in the example of FIG. 1, audio conference 112a comprises three participants (participants 104a and 104b and common participant 105). Audio conference 112b comprises four participants (participants 104c, 104d, 104e, and common participant 105). Each participant is associated with a corresponding client device 102.

The computing devices 102 may comprise any desirable computing device, which is configured to communicate with the conferencing system 106 via the networks 110. The computing device 102 may comprise, for example, a personal computer, a desktop computer, a laptop computer, a mobile computing device, a portable computing device, a smart phone, a cellular telephone, a landline telephone, a soft phone, a web-enabled electronic book reader, a tablet computer, or any other computing device capable of communicating with the conferencing system 106 via one or more networks 110. The computing device 102 may include a display device, a processor, memory, and software, including an operating system, a graphical user interface, a browser, or other functionality configured to facilitate communication with the conferencing system 106. It should be appreciated that the hardware, software, and any other performance specifications of the computing device 102 are not critical and may be configured according to the particular context in which the computing device 102 is to be used.

The conferencing system 106 generally comprises a communication system for establishing an audio conference 112 between the computing devices 102. The conferencing system 106 may support audio via a voice network and/or a data network. In one of a number of possible embodiments, the conferencing system 106 may be configured to support, among other platforms, a Voice Over Internet Protocol (VoIP) conferencing platform such as described in U.S. patent application Ser. No. 11/637,291 entitled “VoIP Conferencing,” filed on Dec. 12, 2006, which is hereby incorporated by reference in its entirety. It should be appreciated that the conferencing system 106 may support various alternative platforms, technologies, protocols, standards, features, etc. Regardless of the communication infrastructure, the conferencing system 106 may be configured to establish an audio connection with the computing devices 102, although in some embodiments the audio portion may be removed.

As illustrated in FIG. 1, the conferencing system 106 may establish the audio conferences 112a and 112b by combining audio streams 114 associated with the computing devices 102 and corresponding participant identifiers 115. Audio conference 112a combines audio streams 114a, 114b, and 114f associated with computing devices 102a, 102b, and 102f, respectively. Audio conference 112b combines audio steams 114f, 114c, 114d, and 114e associated with computing devices 102f, 102c, 102d, and 102e, respectively. The common participant 105 operating computing device 102f has an audio stream 114f shared between the audio conferences 112a and 112b.

The conferencing system 106 presents a first conference user interface 108a to the participants in the audio conference 112a and a second conference user interface to the participants in the audio conference 112b. The conferencing system 106 comprises a simultaneous conference control module 120 for controlling various aspects of the simultaneous online conferences. Simultaneous conference control module 120 may include an inter-conference alerts module 116 and a multi-conference display module 118 that comprise the logic or functionality for providing various features related to managing, configuring, controlling, and presenting the simultaneous conferences to the common participant 105.

One of ordinary skill in the art will appreciate that the inter-conference alerts module 116 and a multi-conference display module 118 (and any associated or other modules described herein) may be implemented in software, hardware, firmware, or a combination thereof. In one embodiment, the systems are implemented in software or firmware that is stored in a memory and that is executed by a suitable instruction execution system. In software or firmware embodiments, the logic may be written in any suitable computer language. In hardware embodiments, the systems may be implemented with any or a combination of the following, or other, technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

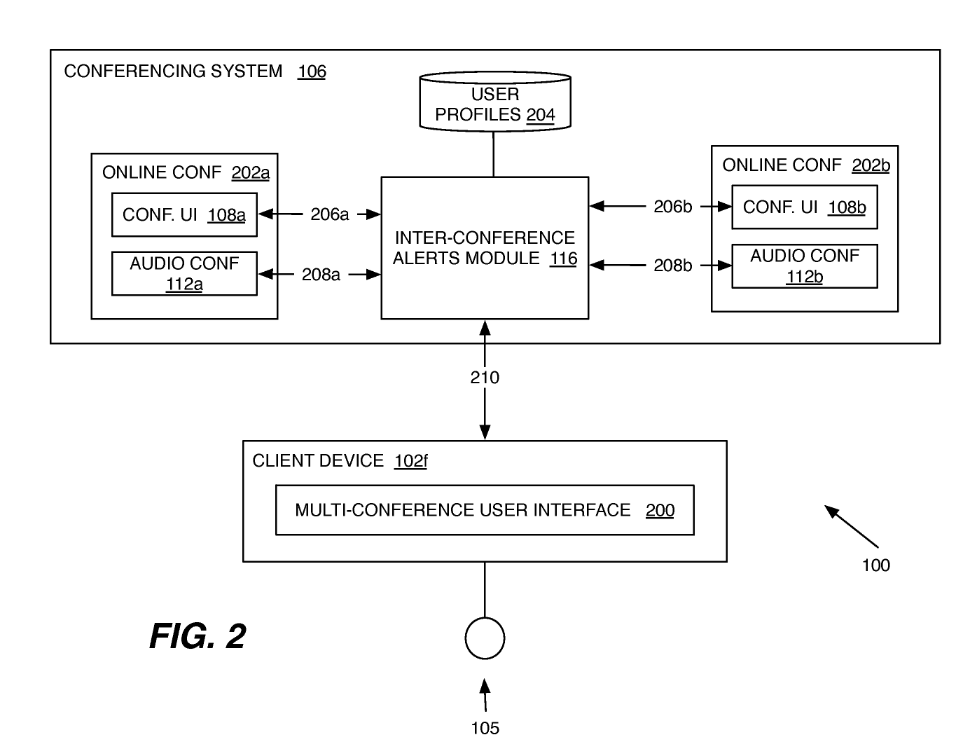

FIG. 2 illustrates the architecture, operation, and/or functionality of an embodiment of the inter-conference alerts module 116. In general, the inter-conference alerts module 116 enables the common participant 105 to view one of the conference user interfaces 108a and 108b and simultaneously receive alerts or notifications associated with the other. A first online conference 202a may comprise audio conference 112a with the corresponding conference user interface 108a. A second online conference 202b may comprise audio conference 112b with the corresponding conference user interface 108b. The conference user interfaces 108 may be configured in the manner described in the above-referenced patent applications to provide various interactive conferencing features to the participants 102.

Inter-conference alert module 116 monitors online conferences 202a and 202b and determines the occurrence of one or events occurring either via the audio conferences 112a and 112b or the conference user interfaces 108a and 108b. In an embodiment, inter-conference alert module 116 may monitor the audio streams 114a, 114b, and 114f associated with audio conference 112a via a connection 208a, and the audio streams 114c, 114d, 114e, and 114f associated with audio conference 112b via a connection 208b. Inter-conference alert module 116 may determine various predetermined events occurring in the audio conferences 112. For example, inter-conference alert module 116 may determine when a particular participant 104 joins or leaves the audio conference 112, when a predetermined number of participants 104 join or leave the audio conference 112, or any other desirable event. A common participant 105 may control the events to be monitored and for which alerts are to be provided by configuring suitable parameters in a user profile (user profiles database 204). In another embodiment, inter-conference alert module 116 may include a speech recognition functionality (as described in the above-referenced patent applications), which determines the words spoken in the audio conference 112. In this manner, participants 102 may customize alerts based on particular topics, agenda items, keywords, etc. as they are discussed.

Inter-conference alerts module 116 may also monitor the activity occurring in the conference user interfaces 108a and 108 via connections 204a and 204b, respectively. Inter-conference alert module 116 may determine when a particular participant 104 joins or leaves the online conference, when a predetermined number of participants 104 join or leave the online conference, or any other desirable event. It should be appreciated that the events may involve any of the features occurring via the conference user interfaces 108, as described in the above-referenced patent applications. In an embodiment, the inter-conference alerts module 116 may determine when the common participant 105 has received a message or chat request from the other participants 104 or when documents, videos, or other media are shared in the conference user interface 108. Additional events may include activity associated with social networks of the participants 104.

As illustrated in FIG. 2 and described in more detail below, the conferencing system 106 may present a specialized multi-conference user interface 200 to the common participant 105. In general, the multi-conference user interface 200 enables the common participant 105 to view one of the conference user interfaces 108a and 108b while simultaneously receiving alerts or notifications identifying the occurrence of the various events described above in the other conference. Inter-conference alert module 116 may maintain a communication channel 210 with the multi-conference user interface 200 for providing the alerts or notifications.

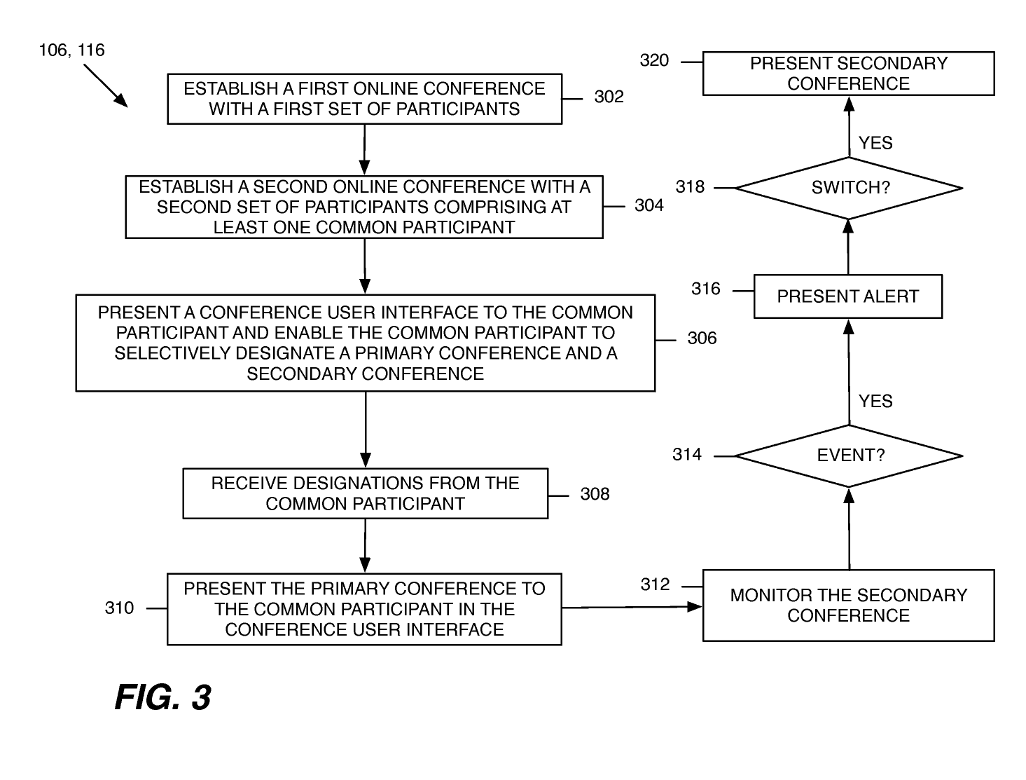

FIG. 3 illustrates a method implemented by an embodiment of the inter-conference alert module 116. At block 302, the conferencing system 106 establishes a first online conference 202a between a first set of participants (e.g., participants 104a and 104b and common participant 105). The online conference 202a may include the audio conference 112a and an associated conference user interface 108a. At block 304, the conferencing system 106 establishes a second online conference 202b with a second set of participants (e.g., participants 104c, 104d, and 104e and common participant 105). The second online conference 202b may include the audio conference 112b and an associated conference user interface 108b.

At block 306, the conferencing system 106 presents a multi-conference user interface 200 to the common participant 105. The multi-conference user interface 200 enables the common participant 105 to selectively designate one of the online conferences 202a and 202b as a primary conference and the other as a secondary conference. It should be appreciated that additional secondary conferences may be designated when the common participant 105 is simultaneously participating in more than two online conferences. At block 308, the conferencing system 106 may receive primary and secondary designations from the client device 102f. It should be appreciated that the common participant 105 and/or a host may also customize these designations when scheduling the online conferences by, for example, configuring user profiles database 124.

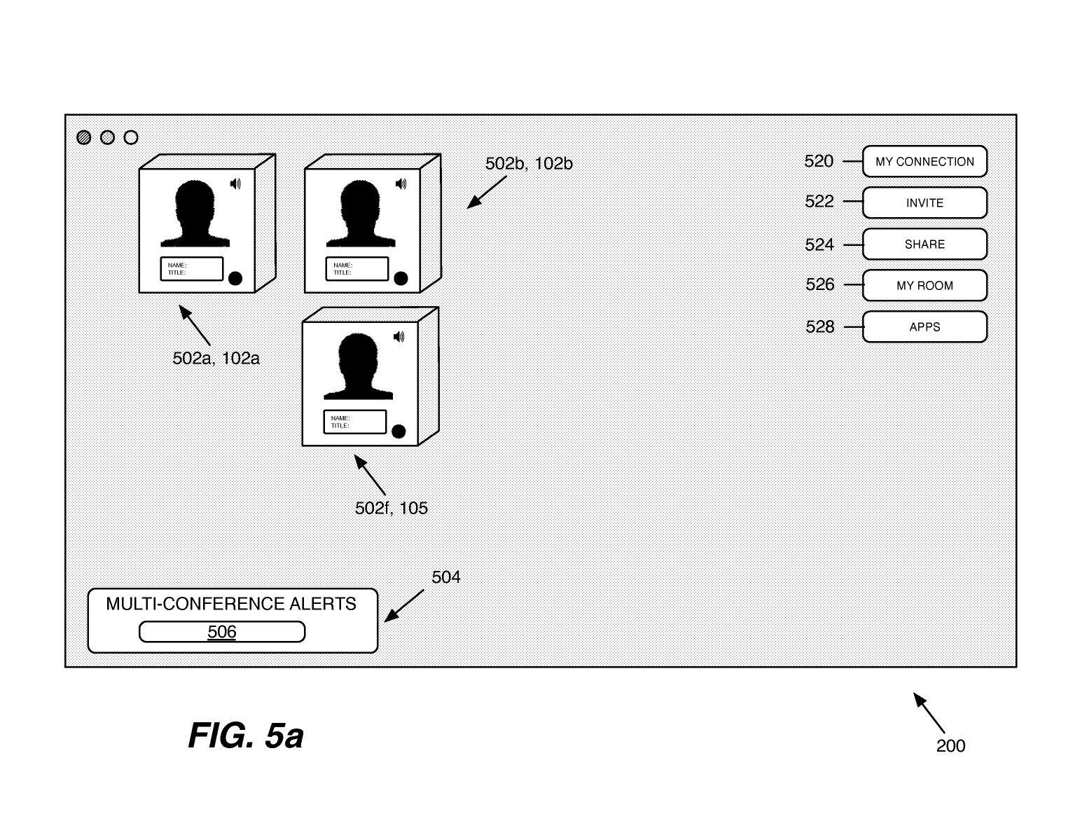

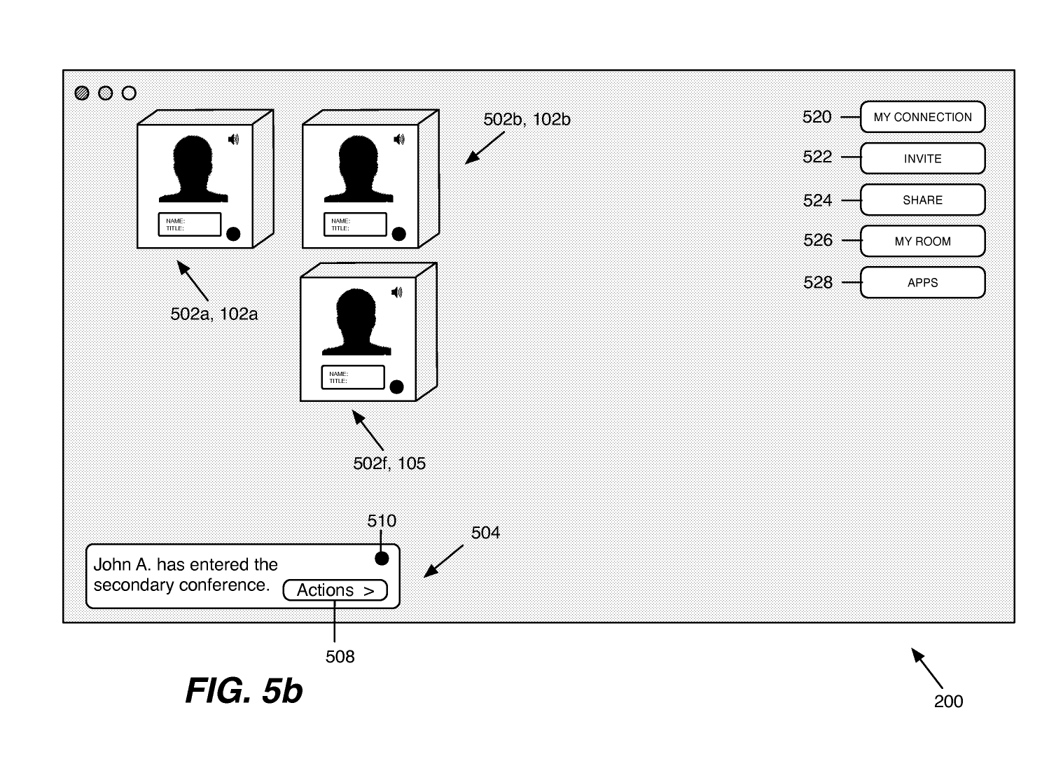

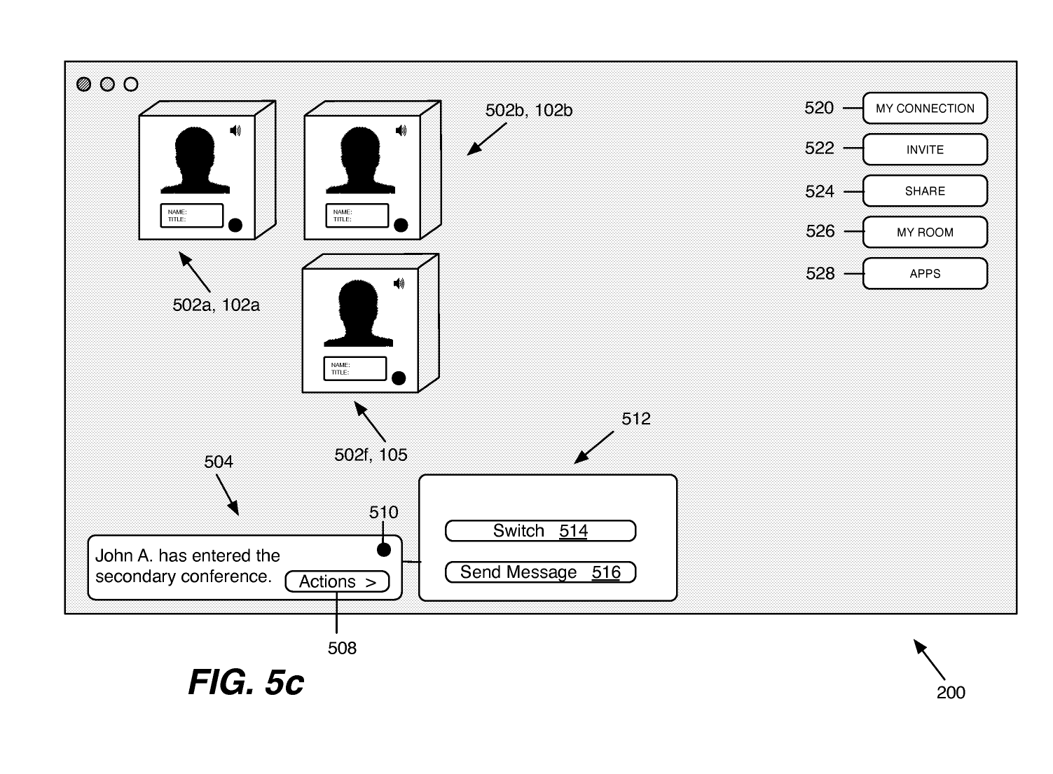

At block 310, the conferencing system 106 presents the multi-conference user interface 200 to the common participant 105. FIGS. 5a-5c illustrate an exemplary embodiment of the multi-conference user interface 200. The multi-conference user interface 200 presents the appropriate conference user interface 108a or 108b according to whichever is designated as the primary conference. In the embodiment of FIG. 5a, the online conference 202a has been designated as the primary conference and, therefore, the conference user interface 108a is presented to the common participant 105. It should be appreciated that the primary conference may be configured as described in the above-referenced patent applications. In an embodiment, the multi-conference user interface 200 may display unique participant objects 502 identifying each of the participants in the primary conference. In the example of FIG. 5a, the multi-conference user interface 200 displays unique participant objects 502a, 502b, and 502f that correspond to the participants 104a, 104b, and common participant 105, respectively. The unique participant objects 502 may be configured in the manner described in the above-referenced patent applications. In an embodiment, a participant object 502 may comprise a graphical representation identifying the participant, profile or contact information, an audio indicator, and other information about the participant. The graphical representation may comprise a picture, photograph, icon, avatar, etc. for identifying the corresponding participant.

The participant objects 502 comprise a cube having multiple display faces. When a participant selects a user interface component, the cube may be expanded to display one or more faces of the object. The user selection may trigger the display of cube faces. Each face may display additional information about the participant. In an embodiment, the cube faces may be configurable by the participant and may display, for example, a social networking profile, updates to a social networking communication channel, video, graphics, images, or any other content. The cube faces may be further selected to return to the original collapsed cube. The participant objects 502 may be rotated (either automatically or via user selection) to display the respective cube faces. It should be appreciated that the participant objects 502 may be configured with additional or alternative visual effects and/or interactive functionality.

Referring again to FIG. 3, at block 312, the secondary conference is monitored by inter-conference module 116 to determine when predetermined event(s) occur in the secondary conference. When a conference event is detected (decision block 314), inter-conference alert module 116 may initiate the display of a corresponding alert or notification to the common participant 105 via the multi-conference user interface 200 (block 316). FIG. 5c illustrates an embodiment for presenting the alerts from the secondary conference to the common participant 105 while viewing the primary conference. In the embodiment of FIG. 5c, the multi-conference user interface 200 may comprise a display region 504 for presenting alert messages 506 from the secondary conference. Display region 504 may be selectively hidden until the alert messages 506 alerts are displayed. In other embodiments, the display region 504 may comprise a persistent alerts window that may scroll the alert messages 506 as they occur.

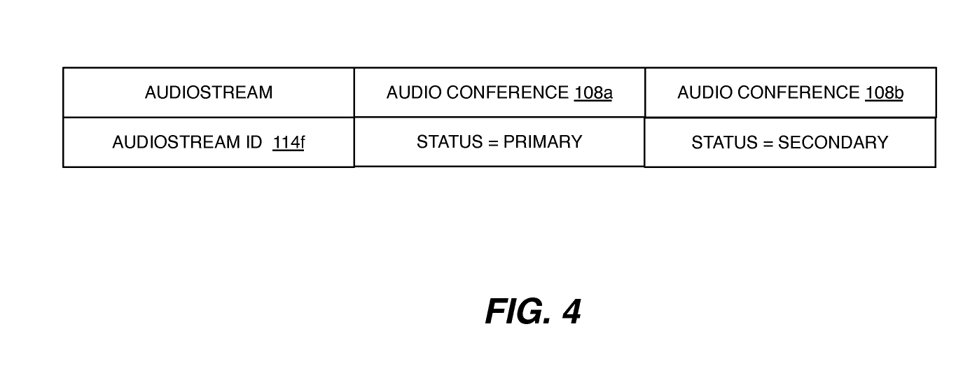

Alert messages 506 may be configured with interactive user interface components for enabling the common participant 105 to select various actions for responding to an alert message 506. As illustrated in FIG. 5b, the display region 506 may comprise an actions button 508 and a close button 510 for disabling or hiding the alert message 506. When the actions button 508 is selected, an actions menu 512 may be displayed for prompting the common participant 105 to take suitable actions based on the type of alert message 506. In the embodiment of FIG. 5c, the actions menu 512 may comprise a switch conferences button 514 and a send message button 516. Referring again to the flowchart of FIG. 3, the switch conferences button 514 may be configured to enable the common participant 105 to switch the designations for the primary and secondary conferences. For example, the alert message 506 may notify the common participant 105 that a particular participant has entered the secondary conference. The common participant 105 may desire to view the conference user interface 108b for the secondary conference. In response to selecting the switch conferences button 514 (or at any other desirable time), the common participant may selectively toggle the primary and secondary designations. The conferencing system 106 may receive the updated designations, modify an appropriate data structure for controlling the primary and secondary designations (FIG. 4), present the other conference user interface 108b as the primary conference, and begin monitoring and providing alerts for the other online conference.

It should be appreciated that the alerts menu 512 may support various other actions or responses. For example, the alert message 506 may comprise a message from one of the participants in the secondary conference. Without leaving the primary conference, the common participant 105 may select the send message button 516 (FIG. 5c) and begin exchanging one or messages (e.g., a direct message, text message, email, chat, social networking message, etc.) with the participant in the secondary conference, or otherwise interact or collaborate with the participant in the secondary conference without switching the primary and secondary designations.

As further illustrated in FIGS. 5a-5c, the conference user interfaces 108a and 108b (which may be selectively displayed in the multi-conference user interface 200 to the common participant 105 or individually provided to the participants 104) may comprise one or more selectable components for accessing various features of the conferencing system 106. A my connection component 520 may launch a display for enabling a participant 104 to configure the existing connection between the computing device 102 and the conferencing system 106. The participant 104 may disconnect a connection to the audio conference 112, establish a new connection to the audio conference 112 (e.g., by dial-out), or reconfigure the existing connection to the audio conference 112. In addition to configuring the audio connection, the participant 104 may also configure the connection to the online conference 202 via the conference user interface 108. In an embodiment, the connection to the online conference may be transferred to another computing device 102 or another client on an existing computing device 102. This may enable the participant 104 to seamlessly maintain a presence in the online conference during the transfer.

An invite component 522 may launch a menu for enabling a participant 104 to invite additional participants 104 to the online conference. Additional participants may be invited by, for example, dialing out to a telephone number, sending an email including information for accessing the conferencing system 106 (including a presently active conference), or sending a message to a web service, such as, for example, a social networking system.

A share component 524 may launch a menu for enabling a participant 104 to insert and share media with other participants in the online conference. A my room component 214 may launch a display for enabling a participant 104 to configure the appearance of the conference user interface 108. The participant 104 may configure the arrangement of the participant objects 502 or configure any other presentation parameter.

An apps component 526 may launch another menu for enabling a participant 104 to launch conference applications. As described in the above-referenced parent patent applications, the conferencing system 106 may host a conference apps store for purchasing various conference applications. An app store component may launch the app store where the participant 104 may purchase conference applications. The my apps component may launch a display for enabling the participant 104 to select from applications that have already been purchased or are otherwise available to the participant 104. A host apps component may display conferencing applications that have been made available by the host of the online conference.

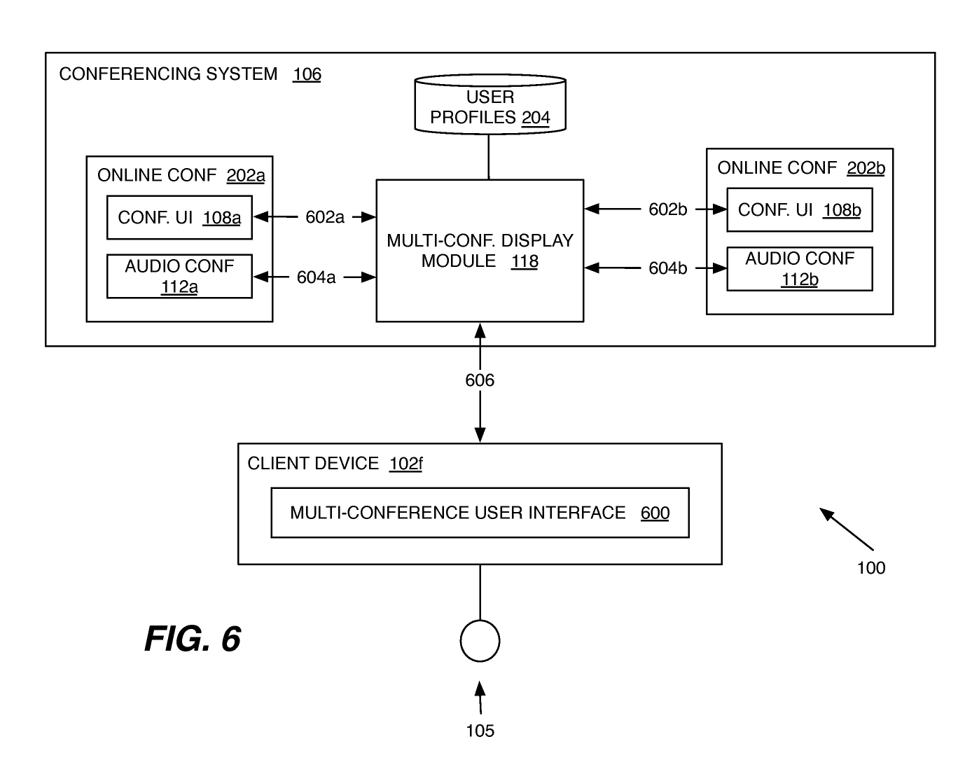

FIG. 6 illustrates the architecture, operation, and/or functionality of an embodiment of the multi-conference display module 118. In general, the multi-conference display module 118 enables the common participant 105 to simultaneously view the conference user interfaces 108a and 108b via a multi-conference user interface 600. Similar to the inter-conference alert module 116 (FIG. 2), multi-conference display module 118 may interface with the online conferences 202a and 202b to control the simultaneous presentation of the conference user interfaces 108a and 108b with their corresponding audio conferences 112a and 112b. Multi-conference display module 118 may interface with the conference user interfaces 108a and 108b via connections 602 and 602b, respectively, and the audio conferences 112a and 112b via connections 604a and 604b, respectively.

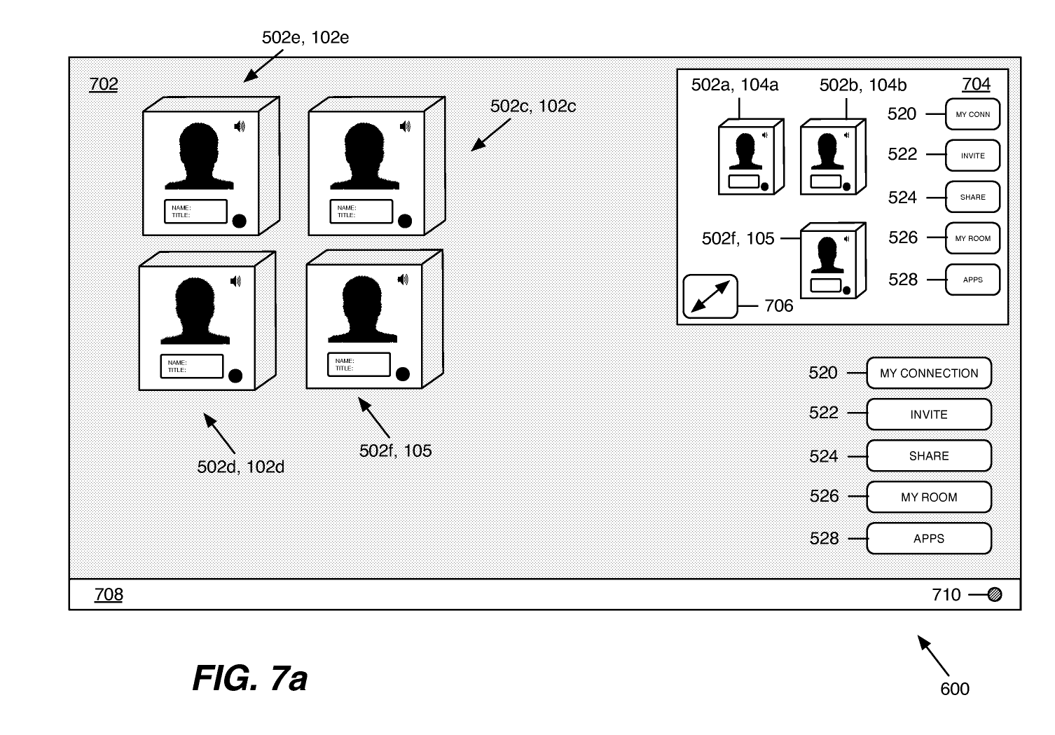

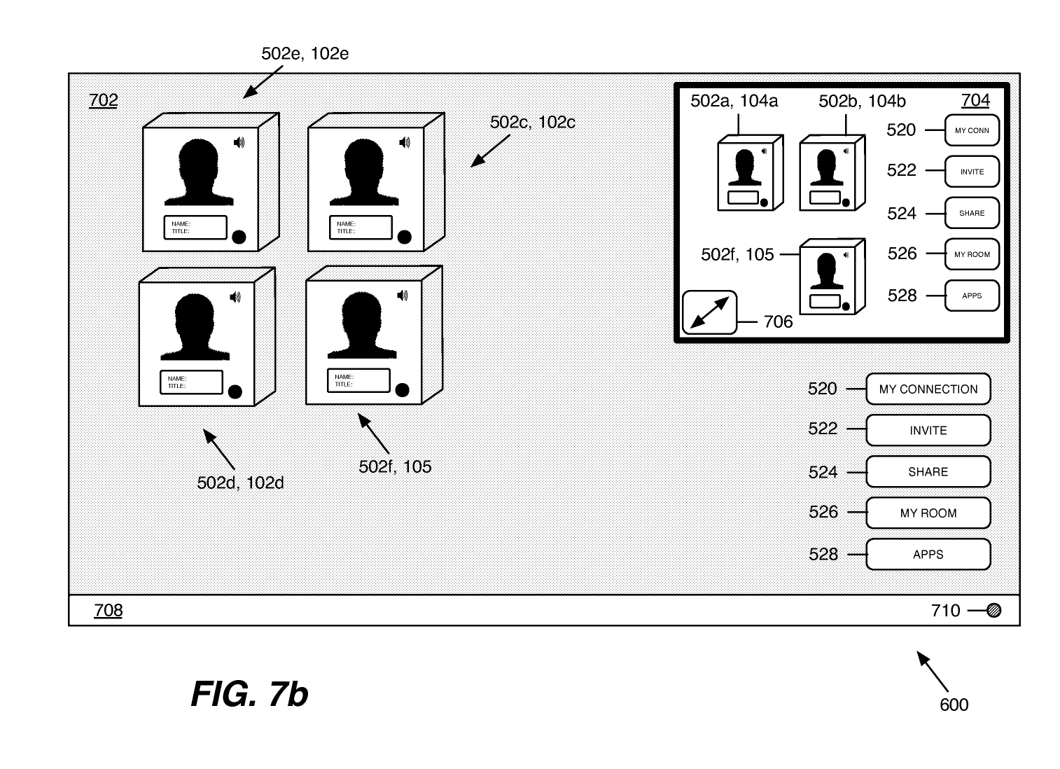

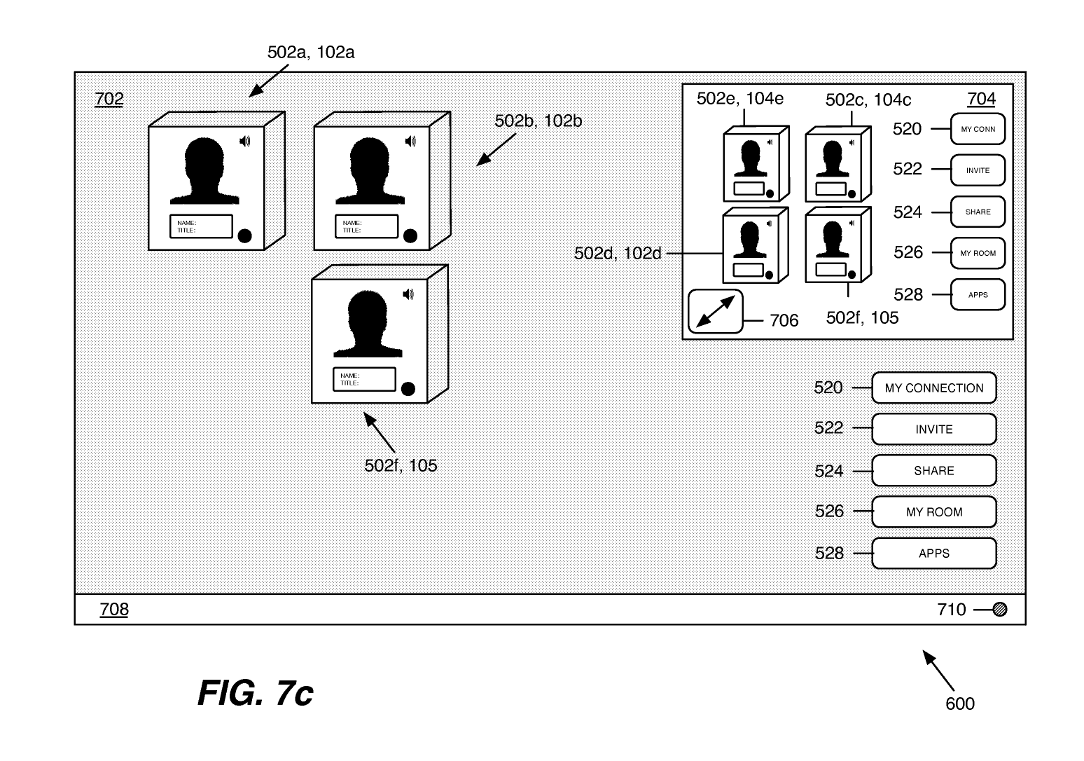

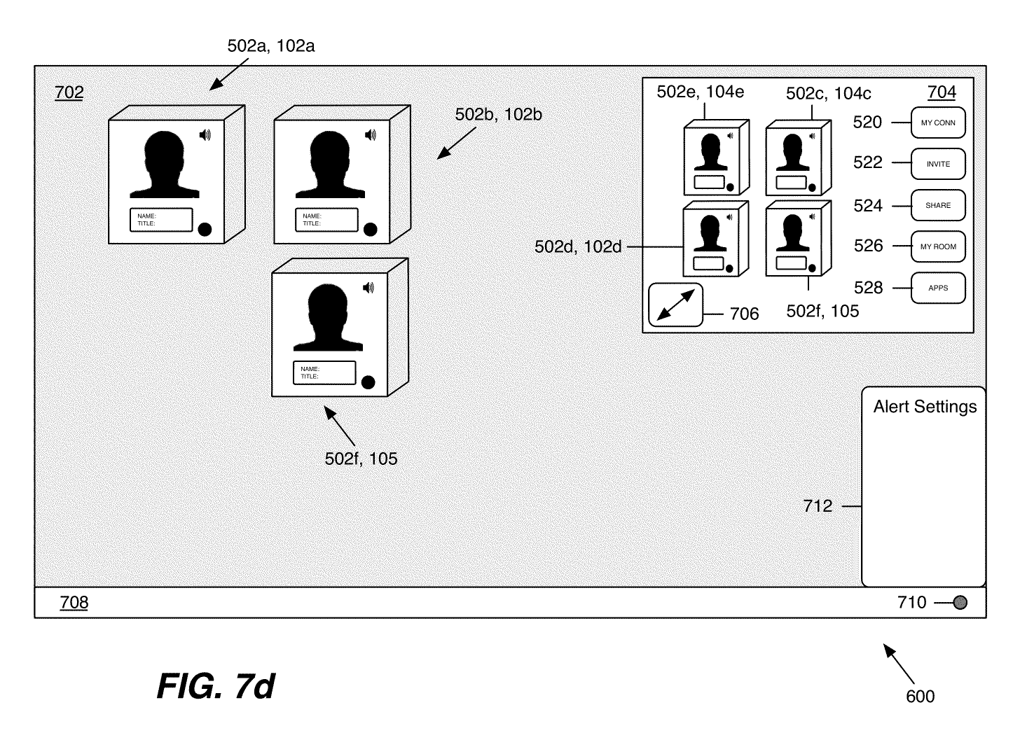

Multi-conference display module 118 provides a specialized multi-conference user interface 600 to client device 112f, via a connection 606, which enables the common participant 105 to simultaneously view both conference user interfaces 108a and 108b. FIG. 7a illustrates an embodiment of a multi-conference user interface 600 comprising a primary display 702 and a secondary display 704. Primary display 702 is associated with online conference 202b, and secondary display 704 is associated with online conference 202a. Accordingly, primary display 702 is configured to present the conference user interface 108b, which may display participant objects 502c, 502d, 502e, and 502f identifying participants 104c, 104d, 104e and common participant 105, respectively. Secondary display 704 is configured to present the conference user interface 108a, which may display participant objects 502a, 502b, and 502f identifying participants 104a, 104b, and common participant 105, respectively.

In an embodiment, primary display 702 may comprise a first frame and the secondary display 704 may comprise a relatively smaller second frame displayed within the first frame. The embedded second frame may be configured as a “picture-in-a-picture” (PIP) with a corresponding component 706 for enabling the common participant to toggle the respective frames. FIG. 7c illustrates the multi-conference display 600 after the primary and secondary displays have been toggled or switched. It should be appreciated that the size and position of the primary and secondary displays may be customized by the common participant 105 (either during the online conferences 202 or based on user profiles database 204), defined by a host, or otherwise configured. For example, the primary display 702 and secondary display 704 may be configured as separate windows or panes that are positioned side-by-side or in any other desirable arrangement.

Regardless the configuration, it should be appreciated that the multi-conference display 600 enables the common participant 105 to simultaneously view the content and/or functionality presented in both conference user interfaces 108a and 108b. The common participant 105 may control the audio portions of the online conferences in any suitable manner. Primary display 702 may define the default audio conference 112 to present. In other embodiments, the common participant 105 may select which audio conference to present by selecting the corresponding display 702 or 704. As illustrated in FIG. 7b, the common participant 105 may select the secondary display 704 to activate audio conference 112a without switching the primary and secondary displays. When audio is activated for the secondary display 704, the border of the frame may be highlighted (or otherwise distinguished) to indicate the source of the audio.

Multi-conference user interface 600 may be further configured to present alerts or notifications associated with the secondary display, as described above in connection with inter-conference alerts module 116. In this regard, it should be appreciated that some embodiments of the computer system 100 may combine one or more aspects of inter-conference alerts module 116 with one or more aspects of multi-conference display module 118. As illustrated in FIG. 7d, multi-conference user interface 600 may include an alerts display region 708 for displaying the alert messages 506 (FIG. 5a). The common participant 105 may customize alert settings by selecting an alert settings button 710, which may launch a menu 712 (FIG. 7d) for customizing alerts provided via alerts display region 708.

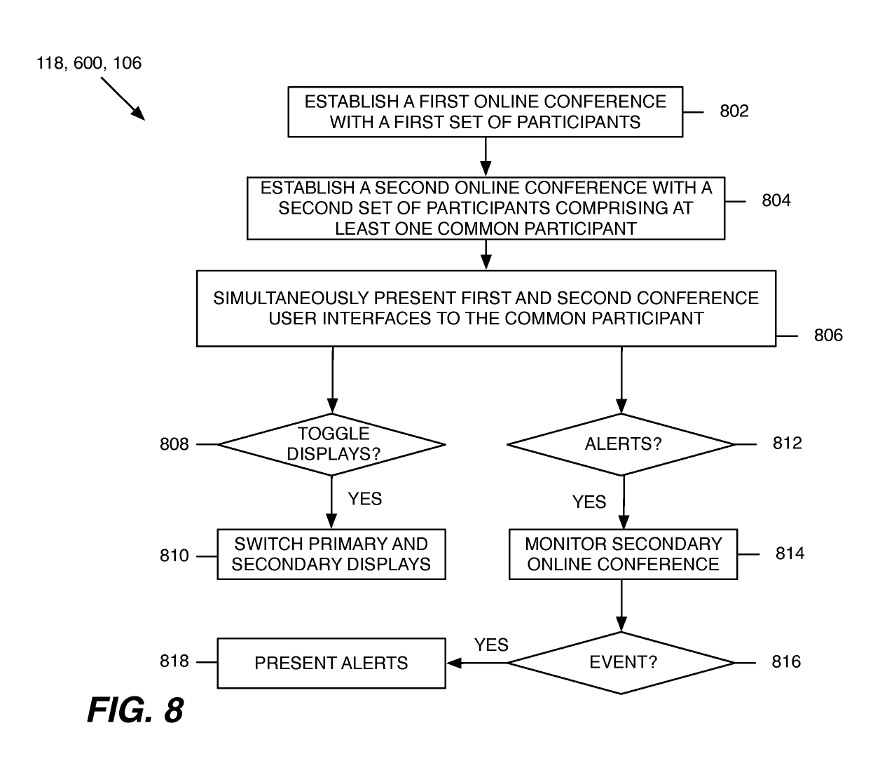

FIG. 8 illustrates a method implemented by an embodiment of the multi-conference display module 118. The conferencing system 106 establishes the first online conference 202a (block 802) and the second online conference 202b (block 804) as described above. At block 806, the conferencing system 106 simultaneously presents the conference user interfaces 108a and 108b to the common participant 105 as a primary display and a secondary display. At decision block 808, the common participant 105 may selectively switch the primary and secondary displays or otherwise customize the presentation of the conference user interfaces 108a and 108b. At block 810, the conferencing system 106 may update the multi-conference display 600. At decision block 812, the common participant 105 may configure alert settings for the primary and/or secondary displays. If the alert feature is activated, at block 814, the conferencing system 106 monitors the appropriate online conference(s) for predetermined events or conference actions (decision block 816). At block 818, the conferencing system 106 may present the alert messages to the multi-conference display 600.

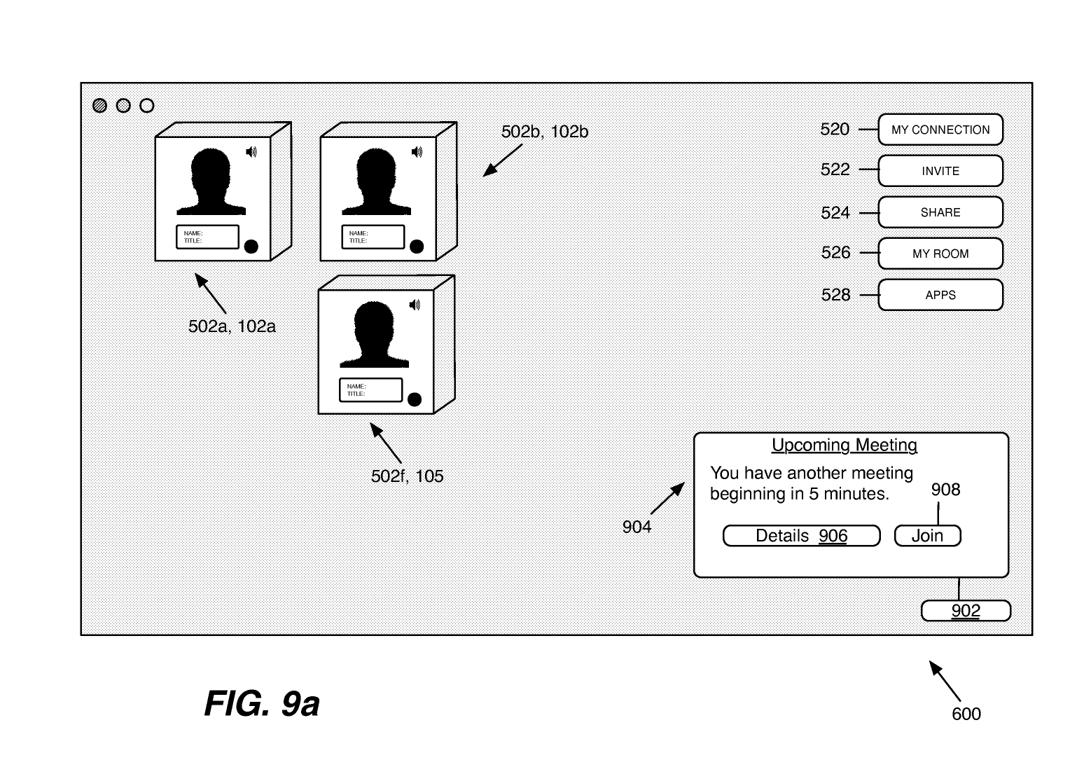

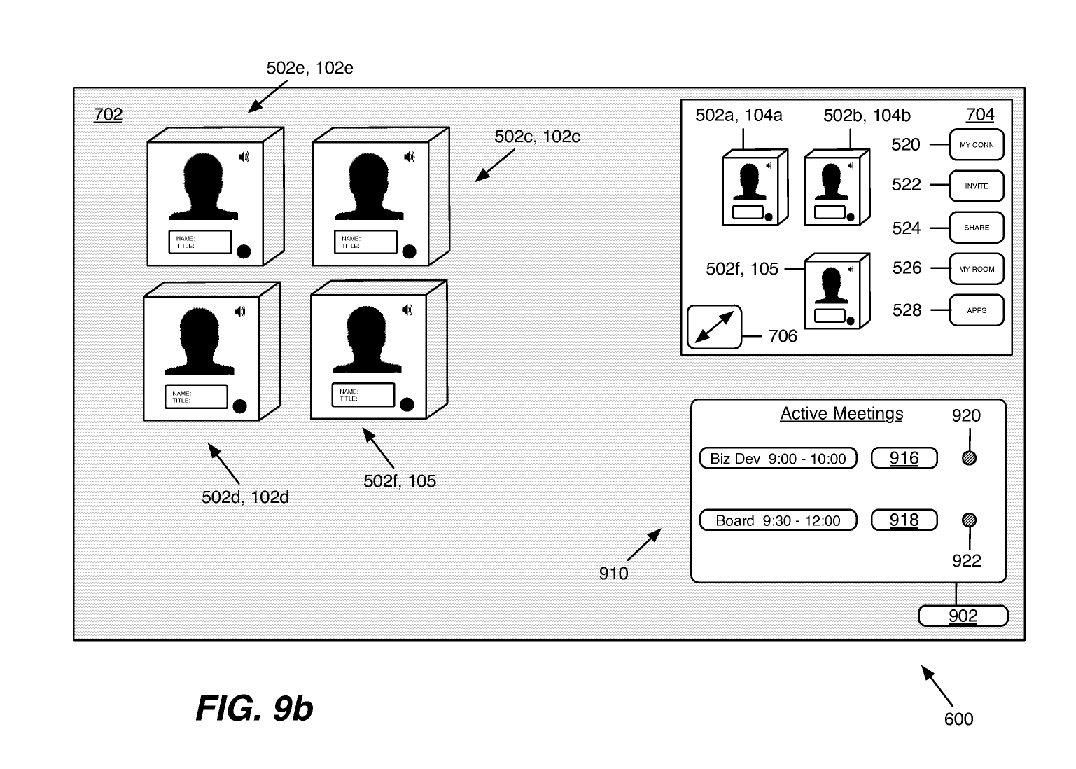

As illustrated in FIGS. 9a & 9b, multi-conference display 600 may further comprise a control panel 902 for providing additional controls and/or features for simultaneously controlling multiple online conferences. In an embodiment (FIG. 9a), the control panel 902 may display an upcoming conferences menu 904. For example, the common participant 105 may be participating in the online conference 202a. In this example, the online conference 202b has not started but will coincide at least partially with the online conference 202a. During online conference 202a, the upcoming conferences menu 904 may alert the common participant 105 that the online conference 202b is about to begin. Details about the upcoming conference may be displayed in a text box 906. A join button 908 may enable the common participant 105 to simultaneously join the online conference 202b, which may then launch a multi-conference display (FIG. 9b) and/or the alert features described above.

As illustrated in FIG. 9b, when multiple conferences are active, the control panel 902 may display an active meetings menu 910. Menu 910 may display details about the active meetings (boxes 912 and 914), as well as primary/secondary buttons 916 and 918 for designating the primary and secondary displays and alert configuration buttons 920 and 922 for separately configuring alert settings for each online conference.

It should be appreciated that one or more of the process or method descriptions associated with the flow charts or block diagrams above may represent modules, segments, logic or portions of code that include one or more executable instructions for implementing logical functions or steps in the process. It should be further appreciated that the logical functions may be implemented in software, hardware, firmware, or any combination thereof. In certain embodiments, the logical functions may be implemented in software or firmware that is stored in memory or non-volatile memory and that is executed by hardware (e.g., microcontroller) or any other processor(s) or suitable instruction execution system associated with the multi-platform virtual conference location system. Furthermore, the logical functions may be embodied in any computer readable medium for use by or in connection with an instruction execution system, apparatus, or device, such as a computer-based system, processor-containing system, or other system associated with the multi-platform virtual conference location system that can fetch the instructions from the instruction execution system, apparatus, or device and execute the instructions.

It should be noted that this disclosure has been presented with reference to one or more exemplary or described embodiments for the purpose of demonstrating the principles and concepts of the invention. The invention is not limited to these embodiments. As will be understood by persons skilled in the art, in view of the description provided herein, many variations may be made to the embodiments described herein and all such variations are within the scope of the invention.

What is claimed is:

1. A method for providing multiple online conferences via a conference user interface, the method comprising:
a conferencing system establishing a first online conference with a first set of participants and a second online conference with a second set of participants, the first and second sets of participants having a common participant simultaneously participating in both;
the conferencing system presenting a conference user interface to a client device associated with the common participant;
the common participant designating the first online conference as a primary conference and the second online conference as a secondary conference;
the conferencing system providing the primary conference to the client device in the conference user interface;
the conferencing system monitoring and determining an event occurring in the secondary conference; and
in response to the event, the conferencing system presenting a notification to the client device, via the conference user interface, the notification indicating the occurrence of the event in the secondary conference.

2. The method of claim 1, wherein the first online conference comprises a first audio conference and the second online conference comprises a second audio conference.

3. The method of claim 1, wherein the conferencing system providing the primary conference to the client device in the conference user interface comprises displaying a interactive participant object identifying each of the first set of participants in the primary conference.

4. The method of claim 1, wherein the conferencing system providing the primary conference to the client device comprises presenting a corresponding audio conference.

5. The method of claim 1, wherein the event occurring in the secondary conference is predetermined by the common participant.

6. The method of claim 1, wherein the event comprises one or more of the following: one or more of the second set of participants joining an audio conference; a predetermined participant joining the audio conference; a predetermined number of participants joining the audio conference; and a message from one or more of the second set of participants.

7. The method of claim 1, wherein the notification is presented with a prompt for one or more of the following actions: send a reply to the message; and change the conference user interface to present the secondary conference instead of the primary conference.

8. A computer system comprising:
a conferencing system for establishing a first online conference with a first set of participants and a second online conference with a second set of participants, the first and second sets of participants having a common participant simultaneously participating in both; and
a server configured to communicate with the conferencing system via a communication network, the server comprising one or more processors and an inter-conference alert module, which is stored in a computer readable medium and executed by the processors for enabling the common participant to simultaneously participate in the first and second online conferences, the inter-conference alert module comprising:
logic configured to designate the first online conference as a primary conference and the second online conference as a secondary conference;
logic configured to present the primary conference via a conference user interface to a client device associated with the common participant; and
logic configured to notify the common participant, via the conference user interface, of predetermined events occurring in the secondary conference.

9. The computer system of claim 8, wherein the logic configured to designate the first online conference as a primary conference and the second online conference as a secondary conference comprises:
logic configured to receive a selection via the conference user interface.

10. The computer system of claim 8, wherein the inter-conference alert module further comprises:
logic configured to monitor the secondary conference and determine the predetermined events.

11. The computer system of claim 8, wherein the first online conference comprises a first audio conference and the second online conference comprises a second audio conference.

12. The computer system of claim 8, wherein conference user interface displays a participant object identifying each of the first set of participants in the primary conference.

13. The computer system of claim 8, wherein the predetermined events comprise one or more of the following: one or more of the second set of participants joining an audio conference; a predetermined participant joining the audio conference; a predetermined number of participants joining the audio conference; and a message from one or more of the second set of participants.

14. The computer system of claim 8, wherein the logic configured to notify the common participant of the predetermined events occurring in the secondary conference comprises:
logic configured to display a notification in the conference user interface.

15. The computer system of claim 14, wherein the notification is presented with a prompt for one or more of the following actions: send a reply to the message; and change the conference user interface to present the secondary conference instead of the primary conference.

16. A computer program embodied in a computer readable medium and executable by a processor for enabling simultaneous participation in at least two online conferences, the computer program comprising:
logic configured to establish a first online conference with a first set of participants and a second online conference with a second set of participants, the first and second sets of participants having a common participant simultaneously participating in both;
logic configured to present the first online conference via a conference user interface to a client device associated with the common participant; and
logic configured to notify the common participant, via the conference user interface, of predetermined events occurring in the secondary conference.

17. The computer program of claim 16, wherein the logic configured to notify the common participant of the predetermined events comprises:
logic configured to monitor the second online conference and determine the predetermined events.

18. The computer program of claim 16, wherein the conference user interface displays a participant object identifying each of the first set of participants in the first online conference.

19. The computer program of claim 16, wherein the predetermined events comprise one or more of the following: one or more of the second set of participants joining the second online conference; a predetermined participant joining the second online conference; a predetermined number of participants joining the second online conference; and a message to the common participant.

20. The computer program of claim 16, wherein the logic configured to notify the common participant of the predetermined events comprises:
logic configured to present a notification in the conference user interface, the notification comprising a prompt for one or more of the following actions: send a reply to the message; and change the conference user interface to present the second online conference instead of the first online conference.
